(19) United States
(12) Patent Application Publication
(10) Pub. No.: US 2005/0171968 A1
(43) Pub. Date: Aug. 4, 2005

(54) System and method for providing a logical view of a data source

(76) Inventors: Paul Yuknewicz, Redmond, WA (US); Antoine Cote, Redmond, WA (US); Yu-Fang Li, Woodinville, WA (US); Eric Gruber, Duvall, WA (US)

Correspondence Address: WOODCOCK WASHBURN LLP, ONE LIBERTY PLACE - 46TH FLOOR, PHILADELPHIA, PA, 19103, US

(21) Appl. No.: 10/769,637

(22) Filed: Jan. 30, 2004

(51) Int. Cl. G06F 7/00

(52) U.S. Cl. 707/102

(57) ABSTRACT

A logical view of a data source may be provided. The data source may include a number of data source objects organized according to a data source schema. The data source schema may be retrieved or inferred, and the data source objects may be identified from the data source schema. A logical relationship between the data source objects may be determined based on the data source schema. A logical view of the data source that shows the logical relationship between the data source objects may be displayed. The display may include a tree structure with nodes that correspond to data source objects.

### REFERENCE TO RELATED APPLICATIONS

This application is related by subject matter to U.S. patent application (Ser. No. unknown) entitled “System and Method for Generating a Parameterized Query” filed on Jan. 30, 2004 (Attorney Docket Number MSFT-2958, Client Docket Number 307292.01), U.S. patent application (Ser. No. unknown) entitled “System and Method for Exposing a Child List” filed on Jan. 30, 2004 (Attorney Docket Number MSFT-2959, Client Docket Number 307291.01), and U.S. patent application (Ser. No. unknown) entitled “System and Method for Exposing Tasks in a Development Environment” filed on Jan. 30, 2004 (Attorney Docket Number MSFT-2961, Client Docket Number 307290.01), the contents of which are hereby incorporated by reference in their entirety.

### FIELD OF THE INVENTION

The present invention relates to the field of data retrieval and manipulation and, more specifically, to providing a logical view of a data source.

### BACKGROUND OF THE INVENTION

A development tool such as, for example, VISUAL STUDIO™ from Microsoft Corp. of Redmond, Wash., enables development of a wide range of computing applications. Such applications may include, for example, web applications, extensible markup language (XML) applications, and traditional client applications. If an application is data-driven, then the application may have one or more associated data sources. Such data sources may be for example, databases, web services, extensible markup language (XML) documents, and business objects. Such data sources may be used to categorize, organize, and maintain data that is useful to an application.

Conventional development tools may include a server management console to enable the user to explore and manage databases. Such a server management console may be, for example, SERVER EXPLORER™ from Microsoft Corp. of Redmond, Wash. Such a server management console may enable the user to make data connections and log onto servers. Once connected to a server, the management console may be used to explore the server databases and system services including, for example, event logs, message queues, and performance counters.

Specifically, the management console may provide a physical view of connected databases. The term physical, as used herein, refers to the actual manner in which data is organized in a data source. For example, the physical view may include a tree structure in which each connected database is a top level node. Tables, views, stored procedures, and functions within a particular database may be viewed by opening a node corresponding to the particular database. In turn, columns and triggers for a particular table may be viewed by opening a node corresponding to the particular table. Additionally, the management console may provide a link to a database designer or table designer that enables the user to visually design a database or data tables. Furthermore, the management console may enable the user to add, delete, and modify data source elements in the physical view.

Importantly, resources from the server management console may be imported into a development tool designer. When such resources are imported, the designer may automatically create components that reference the imported resources. For example, a data table node from the physical view discussed above may be imported into the designer. The data table node may be dragged and dropped onto a designer surface. Once dropped onto the designer, an object may be created with an interface to view and manipulate the database.

A drawback of conventional server management consoles is that, because they provide a physical view of connected data sources, they do not offer a consistent experience for viewing and manipulating different heterogeneous data sources. For example, a database may organize data in a physical layout including tables which, in turn, include rows and columns, while an extensible markup language (XML) document may organize data into a different physical layout including elements, sub-elements, and attributes. In addition to being inconsistent across different types of data sources, a physical view be confusing to a user because it does not necessarily organize data in a manner that is intuitive to users.

Thus, there is a need in the art for systems and methods for providing a logical view of a connected data source. Such a logical view will offer a consistent experience for viewing and manipulating different heterogeneous data sources. Additionally, such a logical view will make data from middle tier or object sources of data as easy to target as traditional database data. Furthermore, such a logical view will present data in a logical manner that is intuitive to users. It is desired that data source objects may be imported from the logical view into a designer, and that the designer may generate interfaces for viewing, managing, and manipulating the data source objects. It is further desired that such a logical view enable users to explore, add, delete, and modify data source elements directly from the development tool. Systems and methods with these and other characteristics are desired.

### SUMMARY OF THE INVENTION

Systems and methods for providing a logical view of a data source are disclosed. The data source may include a number of data source objects organized according to a data source schema. The data source schema may be retrieved or inferred, and the data source objects may be identified. A logical relationship between the data source objects may be determined based on the data source schema. A logical view of the data source that shows the logical relationship between the data source objects may be displayed.

According an aspect of the invention, an interface may be provided that enables a user to identify the data source. Alternatively, a reference such as, for example, a uniform resource locator that identifies the data source may be detected. Once the data source is identified, the data source schema may be retrieved from the data source. Alternatively, the data source schema may be retrieved from a document that is available locally.

According to another aspect of the invention, if the data source schema is not available, then the data source schema may be inferred. Once the data source schema is retrieved or inferred, an interface may be provided that enables the user to select particular data source objects to include in the logical view of the data source.

According to another aspect of the invention, the logical view of the data source may be displayed in a logical data source interface. The logical data source interface may include a logical tree structure with nodes corresponding to data source objects. The data source interface may enable the user to add, modify, and delete a data source object, and such changes may be propagated back to the data source. The data source interface may also enable the user to associate a data source object with a designer object in a designer interface. Upon associating the data source object with the designer object, a display interface may be generated within the designer object to enable the user to view, manage, and manipulate the data source object. A default interface to view, manage, and manipulate the data source object may be selected by the user in the logical data source interface. The logical data source interface may also be filtered to display only data source objects that are associated with a selected designer object.

Additional features and advantages of the invention will be made apparent from the following detailed description of illustrative embodiments that proceeds with reference to the accompanying drawings.

### BRIEF DESCRIPTION OF THE DRAWINGS

The illustrative embodiments will be better understood after reading the following detailed description with reference to the appended drawings, in which:

FIG. 1 is a block diagram representing a general purpose computer system in which aspects of the present invention and/or portions thereof may be incorporated;

FIG. 2 is a block diagram of an exemplary prior art development environment;

FIG. 3 shows an exemplary prior art development tool interface;

FIG. 4 is a block diagram of an exemplary development environment in accordance with the present invention;

FIG. 5 shows an exemplary development tool interface in accordance with the present invention;

FIG. 6 shows an exemplary development tool interface with a business object display options drop down menus in accordance with the present invention;

FIG. 7 shows an exemplary development tool interface with a property display options drop down menus in accordance with the present invention;

FIG. 8 shows an exemplary data configuration wizard in accordance with the present invention; and

FIG. 9 shows a flowchart of an exemplary method for providing a logical view of a data source in accordance with the present invention.

### DETAILED DESCRIPTION OF ILLUSTRATIVE EMBODIMENTS

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

We will now explain the present invention with reference to presently preferred, exemplary embodiments. We will first describe illustrative computing and development environments in which the invention may be practiced, and then we will describe presently preferred implementations of the invention.

Illustrative Computer Environment

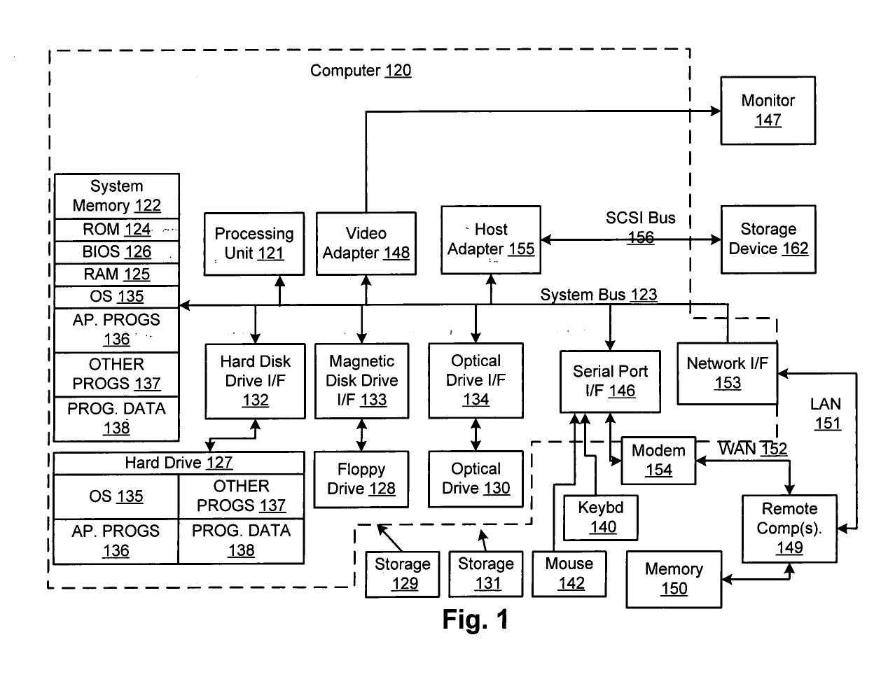

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or an application service. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application 212 programs 136, other program modules 137 and program data 138. A user may enter commands and information into the personal computer 120 through input devices such as a keyboard 140 and pointing device 142 such as a mouse. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156 The personal computer 120 may operate in a networked environment using logical connections to one or more remote computers, such as a remote computer 149. The remote computer 149 may be another personal computer, a application service, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

Exemplary Development Environment

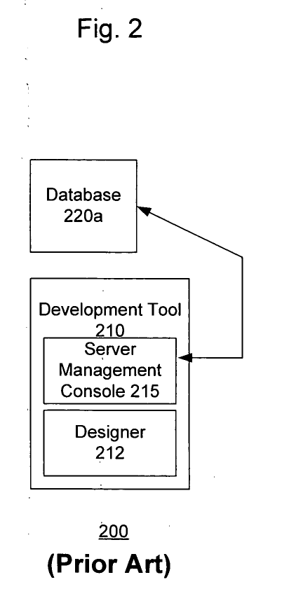

An exemplary prior art development environment is shown in FIG. 2. Generally, development tool 210 enables the development of computing applications. Database 220a operates in connection with development tool 210 to categorize, organize, and maintain data that is useful to applications.

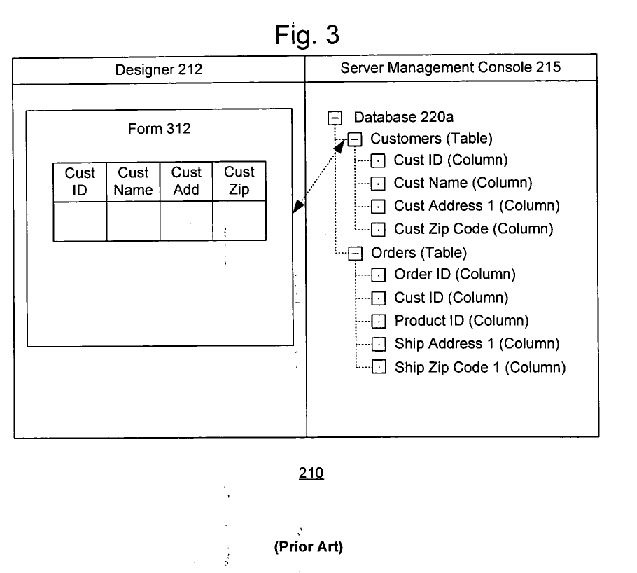

Development tool 210 includes server management console 215 that enables database 220a to be explored, managed, and manipulated at development tool 210. Server management console may be, for example, SERVER EXPLORER™ from Microsoft Corp. of Redmond, Wash. Server management console 215 may enable the user to connect and log on to database 220a. Once connected to database 220a, server management console 215 may be used to explore database 220a and system services including, for example, event logs, message queries, and performance counters. Specifically, server management console 215 may provide a physical view of data source objects database 220a. Such data source objects may include, for example, tables, stored procedures, columns, and triggers. Such a physical view is discussed in detail below with reference to FIG. 3.

Development tool 210 also includes designer 212, which is an interface that enables the user to create, view, manage, and manipulate objects associated with a development project. Such objects may include, for example, forms and controls. A form is an object that enables the presentation of information to the user and the acceptance of input information from the user. A form may expose properties which define its appearance, methods which define its behavior, and events which define its interaction with the user. By setting its properties and writing code to respond to its events, a user may customize a form to meet the requirements of an application. A simple way to define a user interface for a form is to place controls on the form's surface.

A control is an object that is contained within a form. A control may be an object such as, for example, a data grid view, a drop down list, a combo-box, a button, or a check-box. Each type of control has its own set of properties, methods, and events that make it suitable for a particular purpose. The designer 212 enables a user to add controls to a form. For example, the designer 212 may enable a control to be added to a form by dragging and dropping the control from a toolbox, double clicking on the control in a toolbox, or selecting the control in a toolbox and lassoing an area in the form. Once a control is added to a from, the designer 212 enables the control to be aligned and positioned within the form.

Importantly, a designer object within designer 212 may be associated with a database object within server management console 215. For example, a form in the designer 212 may be associated with a particular data table within database 220a. There are a number of methods for associating a designer object with a database object. For example, a database object may be dragged from server management console 215 and dropped into an object within designer 212. When a designer object is associated with a database object, the object may be automatically populated with elements of the database object. For example, if a designer object is associated with a data table, the designer object may be automatically populated with the columns of the data table.

Referring now to FIG. 3, server management console 215 displays a physical tree structure that provides such a physical view of database 220a. A plus “+” character, a minus “−” character, or a period “.” character is shown adjacent to each node. The plus character indicates that a node has child nodes which are not currently displayed. The a minus character indicates that a node has child nodes which are currently displayed. The period character indicates that a node does not have child nodes. The physical tree structure includes a top level node corresponding to database 220a. The physical tree structure also includes second level nodes which correspond to Customers and Orders data tables. The physical tree structure also includes third level nodes which correspond to columns within the Customers and Orders data tables.

Importantly, as shown by the double arrowed dashed line in FIG. 3., designer 212 includes a form 312 which is associated with the Customers data table. Form 312 includes a grid type interface for displaying the Customers data table. The gird includes columns which correspond to the columns of the Customers data table shown in the physical tree structure.

In addition to associating data source objects with designer objects, the physical tree structure shown in FIG. 3 may enable the user to add, delete, and modify data source objects. Additionally, the physical tree structure shown in FIG. 3 may provide a link to a database designer or table designer that enables the user to visually design a database or data tables.

A drawback of server management console 215 is that, because it provides a physical view of connected data sources, it does not offer a consistent experience for viewing and manipulating different heterogeneous data sources. Furthermore, a physical view be confusing to a user because it does not necessarily organize data in a manner that is intuitive to users. Thus, systems and methods of the present invention are directed to providing a logical rather than a physical view of connected data sources.

Systems and Methods of the Present Invention

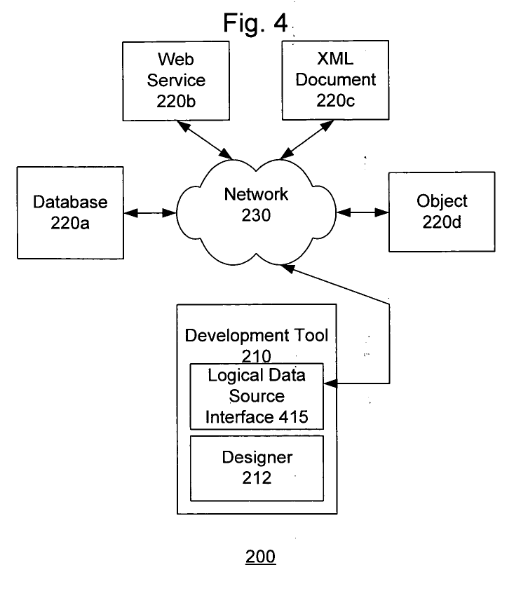

An exemplary development environment 400 in accordance with the present invention is shown in FIG. 4. Development tool 210 enables the development of computing applications. Data sources 220a-d operate in connection with development tool 210 to categorize, organize, and maintain data that is useful to applications. Data sources 220a-d include database 220a, web service 220b, extensible markup language (XML) document 220c and business object 220d. As should be appreciated, other types of data sources are contemplated in accordance with the present invention.

Network 230 may be a local are network (LAN) or a wide area network (WAN) such as, for example, the Internet. As should be appreciated, XML document 220c and business object 220d may be stored locally at development tool 210 and need not necessarily be accessed via network 230. Additionally, database 220a may be on a local server or file at development tool 210. Also, web service “proxy” objects may be stored locally or referenced and may delegate to a remote service. Furthermore, XML document 220c and object 220d may be stored in a referenced assembly.

Unlike development tool 210 of FIG. 2, development tool 210 of FIG. 4 includes logical data source interface 415. Logical data source interface 415 enables data sources 220a-d to be explored, managed, and manipulated at development tool 210. Logical data source interface 415 may enable the user to connect and log on to data sources 220a-d. Once connected to data sources 220a-d, logical data source interface 415 may provide a logical view of data source objects within data sources 220a-d. Such a logical view offers a consistent experience for viewing and manipulating different heterogeneous data sources 220a-d. Furthermore, the logical view organizes data in a manner that is intuitive to users. Such a logical view is discussed in detail below.

Logical data source interface 415 may enable a data source object to be associated with a designer object within designer 212. There are a number of methods for associating a data source object with a designer object. For example, a data source object may be dragged from logical data source interface 415 and dropped into an object within designer 212. When a data source object is associated with a designer object, the designer object may be automatically populated with elements of the data source object.

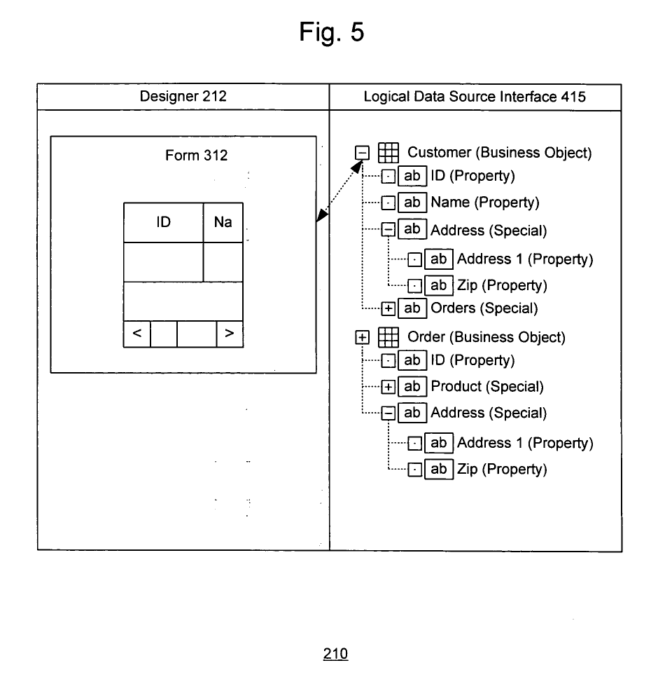

Referring now to FIG. 5, logical data source interface 415 displays a logical tree structure that provides a logical view of database 220a. As should be appreciated, other views are contemplated in accordance with the present invention such as, for example, an object diagram view. As should also be appreciated, although not shown in FIG. 5, data from other connected data sources 220b-d may be included in the logical view. Top level nodes in the tree structure correspond to business objects, namely a customer and an order object. Second level nodes in the tree structure correspond to properties of the business objects. As shown, some of the properties within the tree structure have been marked “Special”. The term special, as used herein, refers to a property type that has corresponding child properties. For example, the “Address” property is a property of the type Address that has child properties “Address1” and “Zip”. Third level nodes in the tree structure correspond to child properties of the special properties. As should be appreciated, the “Address” special properties are open and their child properties are exposed. The “Orders” and “Product” special properties are closed but may also be opened to expose their child properties.

Importantly, the data in the logical view shown in FIG. 5 is not organized according to physical objects such as data tables. Thus, the logical provides a consistent view of data across different types of heterogeneous databases 220a-d. Furthermore, the data is organized in a manner that is intuitive to the user. For example, the user would expect to find portions of the address, such as “Address1” and “Zip”, in a single Address type property. Accordingly, the logical view of FIG. 5, includes an address type property. By contrast, the database view of FIG. 2 includes the “Address1” and “Zip” columns with other customer and order columns and does not separately distinguish them as address columns.

Each element within the logical tree structure has an associated icon that is displayed adjacent to the element. The icon indicates the type of display interface that is generated to display the element in an associated designer object. Specifically, the grid icon next to each business object indicates that a grid display will generated to display the business object. The text box icon next to each property indicates that a text box input field will generated to display the property. The text box icons include a rectangular box surrounding the letters “ab”.

As shown by the double arrowed dashed line in FIG. 5, form 312 is associated with the Customers business object. Form 312 includes a grid type interface for displaying the Customers data source object. The grid may include columns corresponding to the properties of the Customers business object. As should be appreciated, although only the “ID” and a portion of the “Name” column are shown in the grid, the grid may be scrolled to display remaining columns.

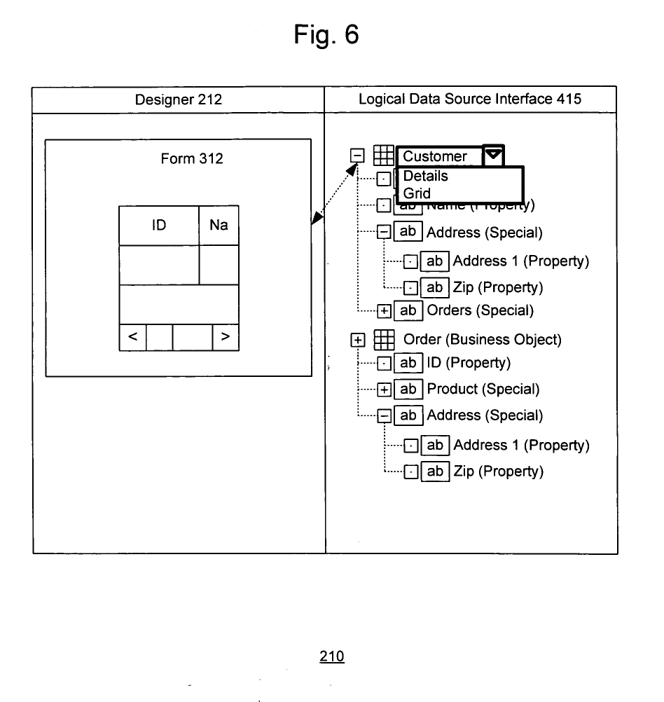

Logical data source interface 415 may enable the user to select a type of display interface with which to display each data source object in designer 212. Referring now to FIG. 6, the Customer object includes a drop down menu that enables the user to select a display interface type. As shown, the display interface types include a grid interface and a details interface. A details interface displays individual records with record attributes in separate text boxes. The details interface includes scroll controls to scroll though the records.

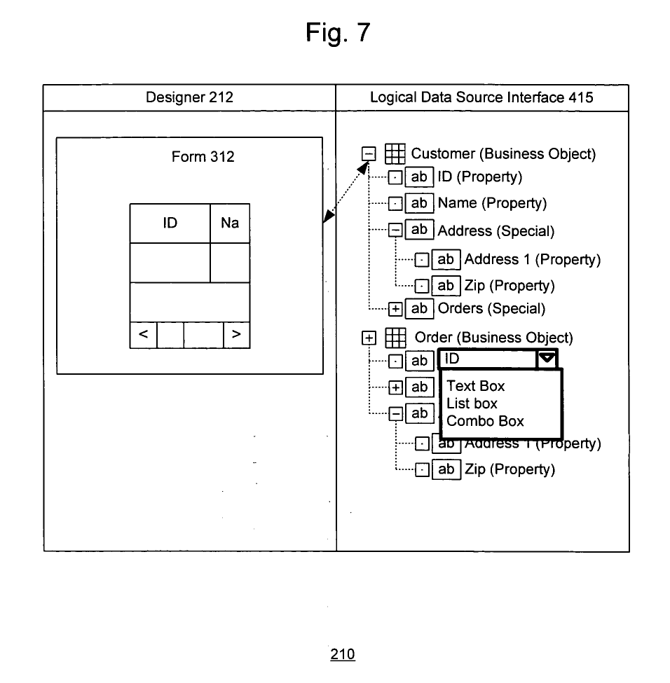

Referring now to FIG. 7, the Order ID property includes a drop down menu that enables the user to select a display interface type with which to display the Order ID property. As shown, the display interface types include a text box, a list box, and a combo box.

The list of display interfaces shown in the drop down menus of FIGS. 6 and 7 may be extensible. Therefore, it may be possible for a user to create an interface and add it to the list. Furthermore, development tool 210 may remember the selected interface for each schema element. Thus, each time the user works against a particular schema element, development tool 210 may generate the selected interface by default. Information about the selected interface for each schema element may, for example, be stored in an extensible markup language (XML) document at development tool 210.

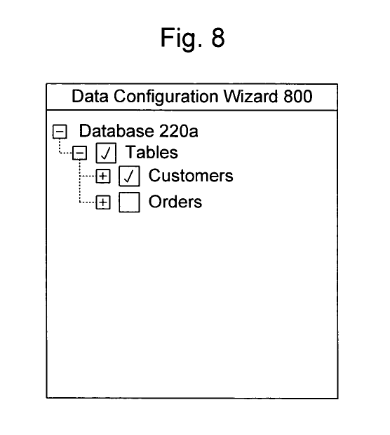

Logical data source interface 415 may enable the user to connect to new data sources. When the user connects to a new data source, a data configuration wizard may be displayed that enables the user to select particular data source objects to be included in the logical view of the data source. Referring now to FIG. 8, data configuration wizard 800 enables the user to select particular data source objects to display in a logical view of the database 220. A check box input field is displayed adjacent to each corresponding data source object. A check indicates that a corresponding object is selected. As shown, the user has selected to include the Customers data table. The user has selected not to include the Orders data table. Thus, when a logical view is generated in response to wizard 800, the logical view will not include Orders data.

The user may make changes to the logical structure of a data source using logical data source interface 415. Specifically, the user may add and delete data source objects. For example, the user may remove the Customers data table from database 220a. Furthermore, the user may display data source objects in designer 212 and then modify the displayed data source objects. For example, the user may add a record to the Customers data table by adding a row to the grid interface displayed in form 312 of FIG. 5. The changes made by the user may be propagated back to the data sources 220a-d.

The logical view shown in logical data source interface 415 may be filtered according to a selected designer object within designer 212. For example, if form 312 of FIG. 5 is selected, the logical view may be filtered to display only the data sources with which form 312 is associated.

Development tool 212 may also include a properties interface which displays properties of objects within the development environment 400. The properties interface may be configured to display properties of particular data source objects in logical data source interface 415. For example, if the Customer object is selected within logical data source interface 415, then the properties of the Customer object may be displayed in the properties interface.

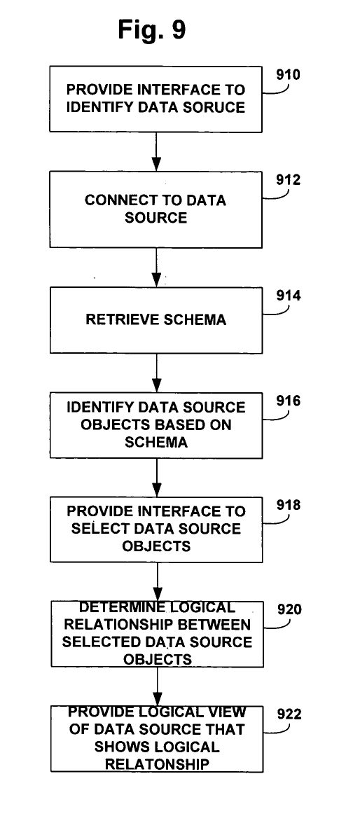

A flowchart of an exemplary method for providing a logical view of a data source in accordance with the present invention is shown in FIG. 9. At step 910, an interface is provided that enables the user to identify a data source. Logical data source interface 415 may provide a link to a builder dialog or wizard to enable the user to identify a data source. At step 912, logical data source interface 415 connects to the data source. At step 914, a data source schema is retrieved from the data source.

Steps 910-914 are optional steps. In place of steps 910-914, logical data source interface 415 may detect a document that includes the data source schema and retrieve the data source schema directly from the detected document. The document may be part of a development project managed by development tool 210.

Alternatively, logical data source interface 415 may detect a reference that identifies the data source and may connect to the data source using the reference. The reference may be, for example, a uniform resource locator (URL) or a reference to an assemnbly. The reference may also be part of a development project managed by development tool 210.

Additionally, if a data source schema is not available, then, rather than retrieving that data source schema at step 914, development tool 210 may infer the data source schema. The data source schema may be inferred by, for example, using reflection capabilities to inspect the shape of objects returned by a data source. Using reflection capabilities may enable development tool 210 to discover, for example, a set of properties that an object exposes including name and type. Examining the properties may enable relationships between the properties to be inferred. An exemplary set of classes is shown below:

```
Class Customer
  Public CustomerName as String
  Public Orders( ) as Order
  ...
End Class
Class Order
  Public OrderDate As DateTime
End Class
```

By looking at the Customer class, development tool 210 may identify that a data source has one property called ‘Orders’ that is of type ‘Order’. Therefore, a relationship between Customer and Order may be inferred.

At step 916, data source objects within the data source are identified based on the retrieved or inferred data source schema. At step 918, an interface is provided to enable the user to select data source objects to be included in the logical view. Such an interface may be, for example, data configuration wizard 900 of FIG. 9.

At step 920, a logical relationship is determined between the selected data source objects. At step 922, a logical view of the data source is provided. The logical view shows the logical relationship between the selected data source objects. The logical view may be, for example, a logical tree structure as shown in FIGS. 5-7.

Conclusion

Systems and methods for providing a logical view of a data source have been disclosed. The disclosed logical view offers a consistent experience for viewing and manipulating different heterogeneous data sources. Additionally, the disclosed logical view will make data from middle tier or object sources of data as easy to target as traditional database data. Furthermore, the disclosed logical view presents data in a logical manner that is intuitive to humans. Data source objects may be imported from the logical view into a designer, and the designer may generate interfaces for viewing, managing, and manipulating the data source objects. The disclosed logical view may enable a user to explore, add, delete, and modify data source elements directly from the development tool.

While the present invention has been described in connection with the preferred embodiments of the various figures, it is to be understood that other similar embodiments may be used or modifications and additions may be made to the described embodiment for performing the same function of the present invention without deviating therefrom. For example, in addition to a tree structure, the logical view may be displayed using other logical structures such as for example a detailed object diagram. Therefore, the present invention should not be limited to any single embodiment, but rather should be construed in breadth and scope in accordance with the appended claims.

1. A method for providing a logical view of a data source, the data source including data source objects organized according to a data source schema, the method comprising:
determining a logical relationship between the data source objects based on the data source schema; and
displaying a logical view of the data source that shows the logical relationship between the data source objects.

2. The method of claim 1, further comprising providing an interface that enables a user to identify the data source.

3. The method of claim 1, further comprising:
connecting to the data source; and
retrieving the data source schema from the data source.

4. The method of claim 1, further comprising:
detecting a document that includes the data source schema; and
retrieving the data source schema from the document.

5. The method of claim 1, further comprising:
detecting a reference to the data source;
connecting to the data source using the identified reference; and
retrieving the data source schema from the data source.

6. The method of claim 5, wherein detecting the reference to the data source comprises detecting a uniform resource locator that provides a link to the data source.

7. The method of claim 1, further comprising:
determining that the data source schema is not available; and
inferring the data source schema.

8. The method of claim 1, further comprising providing an interface that enables a user to select a data source object to be included in the logical view of the data source.

9. The method of claim 1, comprising displaying the logical view of the data source in a tree structure with nodes that correspond to data source objects.

10. The method of claim 1, further comprising:
providing an interface that enables a user to specify a change to the data source that is one of an addition, deletion, and a modification of a data source object; and
sending a command to the data source to execute the specified change at the data source.

11. The method of claim 1, comprising providing an interface that enables a user to associate a data source object in the logical view of the data source schema with an designer object in a designer.

12. The method of claim 11, further comprising generating an interface in the designer object that enables the user to view the data source object.

13. The method of claim 11, further comprising generating an interface in the designer object that enables the user to modify the data source object.

14. A computer readable medium having computer-executable instructions for performing the steps recited in claim 1.

15. A system for providing a logical view of a data source, the system comprising:
the data source including data source objects organized according to a data source schema; and
a computing device that determines a logical relationship between the data source objects based on the data source schema and displays a logical view of the data source that shows the logical relationship between the data source objects.

16. The system of claim 15, wherein the computing device comprises an interface that enables a user to identify the data source.

17. The system of claim 15, wherein the computing device connects to the data source and retrieves the data source schema from the data source.

18. The system of claim 15, wherein the computing device detects a document that includes the data source schema and retrieves the data source schema from the document.

19. The system of claim 15, wherein the computing device detects a reference to the data source and connects to the data source using the reference.

20. The system of claim 19, wherein the reference is a uniform resource locator that provides a link to the data source.

21. The system of claim 15, wherein the computing device determines that the data source schema is not available and infers the data source schema.

22. The system of claim 15, wherein the computing device comprises an interface that enables a user to select a data source object to be included in the logical view of the data source.

23. The system of claim 15, wherein the logical view of the data source comprises a tree structure.

24. The system of claim 15, wherein the computing device comprises a designer interface.

25. The system of claim 24, wherein the designer interface comprises a designer object that is associated with a data source object from the logical view of the data source.

26. The system of claim 25, wherein the designer object comprises an interface that enables a user to view the data source object.

27. The system of claim 25, wherein the designer object comprises an interface that enables a user to modify the data source object.
